(19) United States
(12) Patent Application Publication
(10) Pub. No.: US 2023/0120476 A1
(43) Pub. Date: Apr. 20, 2023

(54) METHODS AND SYSTEMS FOR CREATION AND DISTRIBUTION OF NON-FUNGIBLE TOKENS

(71) Applicant: FameFeed, Inc., Morristown, NJ (US)

(72) Inventor: Marc Adam Baskin, Morristown, NJ (US)

(73) Assignee: FameFeed, Inc., Morristown, NJ (US)

(21) Appl. No.: 17/968,815

(22) Filed: Oct. 19, 2022

Related U.S. Application Data
(60) Provisional application No. 63/257,828, filed on Oct. 20, 2021.

(51) Int. Cl. G06Q 20/36; H04L 9/32

(52) U.S. Cl. CPC G06Q 20/3672; H04L 9/3213; H04L 2209/60; G06Q 2220/00

(57) ABSTRACT

The current invention discloses a technology platform that powers software applications to create, store, distribute and market “NFTs”, a sequence set in motion by one designated action by the user, from previously created or nearly simultaneously created digital media files. In particular, the technology will facilitate this sequence for creators with no or little knowledge of the technology or methods to create and sett “NFTs”. This technology will give increased functionality to users, creators and curators to build vibrant communities and marketplaces around the “NFI” ecosystems, as well as offer community participants revenue opportunities.

### CLAIM OF PRIORITY

This application claims priority to U.S. provisional patent application no. 63257828 filed Oct. 20, 2021, the entire contents of which are hereby incorporated by reference in their entirety.

### FIELD OF THE INVENTION

The current invention relates to Non-Fungible Tokens, a subsection of Digital Assets within a broader group of Digital Assets commonly known as Cryptoassets, particularly a method of creating (also known as ‘minting’), storing, distributing and marketing of Non-Fungible Tokens, from either a mobile or web based application specifically designed for this purpose or from a third-party mobile or web based application designed to create digital media, digital assets, digital entertainment, or other digital units.

### BACKGROUND OF THE INVENTION

Non-fungible tokens (NFTs), unique and non-interchangeable units of record that details ownership on an immutable blockchain, are very difficult to create, store and distribute. We are at such an early time in the development of blockchain and cryptoasset technologies in general, that it is difficult to acquire or transfer ANY cryptoasset without an extensive amount of knowledge around the related technologies, applications, and technical processes. Non-fungible tokens, currently most popular as signifying ownership of digital creations (art, media, video, etc), have a natural affinity to both creative people and collectors, and not necessarily technology-minded people. In other words, non-fungible tokens are underlying an economy that is exciting for non-techies.

Currently there are, at least, four buckets that the many difficulties surrounding the creation, storage and distribution of NFTs, could fall into:
1. CREATORS—Creators are people who may use a generic application, such as a camera phone, or a third party application, such as TikTok, YouTube, OnlyFans, Patreon, etc., to create entertaining or interesting digital media. For those that have an interest in minting their digital media creations into an NFT, the majority may be characterized in one of the three following ways:
a. A Creator who enjoys, or obsessed with, sharing their creations but can't rise above the ‘noise’ of the millions of other creators
b. A Creator who is much more interested in the fun and skill of making new creations rather than learning everything one needs to figure out to mint, distribute and monetize NFTs, and
c. A Creator who would like an opportunity to make money on a third party application, but knows it's not possible without being in the top 1% and getting millions of views.
2. COLLECTORS—Collectors of NFTs are looking for interesting digital art, digital media or digital properties to acquire, often for both the opportunity of capital appreciation and pride of ownership. Currently, there are many centralized, high profile properties like NBA Top Shots or Cryptopunks, that are prohibitively expensive for novice collectors to acquire. This technology disclosed herein will democratize the creation and distribution process of NFTs so that every person with a camera phone or a digital camera or an image capture device is a potential seller, thereby making the field of potential NET acquisitions cheaper for collectors.
3. NFT TECHNOLOGY—There are, at least, three problems with the current state of NFT Technology:
a. NFTs—Difficult to navigate how to create, mint, distribute and market
b. WALLETS—Difficult to buy NFTs, in the varied marketplaces, get drops, consolidate assets and store NFTs.
c. USERS—Difficult to get comfortable without being a savvy early adopter; currently, not a great user experience for the teenage/young adults (Gen Z) that primarily want to create, share and discover.
4. BRANDS—Consumer brands and properties are interested in the creation of NFTs that either represent, display or include their intellectual property. Currently there is no easy way to connect with and obtain viable NTTs created by consumers loyal to their brand.

### SUMMARY OF THE INVENTION

The invention is a technology platform that powers digital media and entertainment applications and communities in facilitating the creation and distribution of NFTs, offering participants substantial revenue Opportunities previously impractical to scale.

For the purposes of this invention, the term ‘Non-Fungible Tokens’, commonly abbreviated as NET or NFTs (plural), has been defined by the NFT marketplace Opensea, as ‘unique, digital items with blockchain-managed ownership’. Additionally, CB Insights describes a few inherent baseline characteristics for NFTs:
“1) RARE AND UNIQUE—This is where the ‘non-fungible’ part of the NETs comes in (fungible refers to interchangeable goods). NETs are wholly unique, and no two TFTs are identical.
2) INTEROPERABILITY AND TRADE—Due to the open nature of many blockchain standards. TFTs can be moved across different ecosystems, wallets, marketplaces, and more. As a result, users are able to use NETs to trade goods outside of their original contexts e.g., selling video game skins).
3) IMMUTABILITY—Once an NET has been encoded using blockchain technology, no individual can alter its ownership data/history or metadata. NETs allow holders to prove the authenticity and originality of their asset, verified through whatever blockchain they are stored on.
4) OWNERSHIP—Holding an NET token can allow people to prove that they are the owners of a unique asset.” (“NETs: is The Spotlight-Stealing Blockchain Tech a Cash Grab Or The Next Big Thing?”, CBInsights Research Briefs, section titled “What is an NFT?”, https://www.cbinsights.com/research/what-are-nfts/ (Apr. 12, 2021)).

It is an object of the invention to allow creators to—after they have properly acknowledged prompts in the settings of the application (once)—to CREATE (also known as MINT) an NET or multiple NETS with JUST ONE MOTION (i.e. push one digital button, swipe once, tap) immediately after creating a digital asset (image, video, media, voice recording, text, etc.) through a mobile or web application of the immediately previously recorded digital asset.

It is an object of the invention to immediately STORE the newly minted NET or NFTs, as described in the above paragraph, in a DIGITAL WALLET, automatically without additional prompts required.

It is an object of the invention to immediately DISTRIBUTE the newly stored NET or NFTs, as described in the above two paragraphs, to a designated and pre-approved DIGITAL MARKETPLACE, automatically without additional prompts required.

It is an object of the invention to immediately MARKET the newly distributed NFT or NFTs, as described in the above three paragraphs, to interested or pre-curated collectors, through electronic means (email, text, electronic and/or mobile notifications, etc.), automatically without additional prompts required.

It is an object of the invention to allow collectors to purchase the newly created. NET or NFTs either on an individual basis or as a package or bundle with other NFTs either from the same creator or from multiple creators, across marketplaces.

### BRIEF DESCRIPTION OF THE DRAWINGS

FIG. 1 depicts a schematic diagram of a system configured to create and distribute non-fungible tokens, according to at least some embodiments disclosed herein.

FIG. 2 depicts a schematic diagram of a system configured to create and distribute non-fungible tokens, according to at least some embodiments disclosed herein.

FIG. 3 depicts a block diagram of components of a platform configured to create and distribute non-fungible tokens, according to at least some embodiments disclosed herein.

FIG. 4A depicts a flowchart for a method executed by a system configured to create and distribute non-fungible tokens, the flowchart containing a portion of the steps of the method, according to at least some embodiments disclosed herein.

FIG. 4B depicts a flowchart for a method executed by a system configured to create and distribute non-fungible tokens, the flowchart containing a further portion of the steps of the method, the steps of FIG. 4B being combined with the steps of FIG. 4A to show the method, according to at least some embodiments disclosed herein.

FIG. 4C depicts a flowchart for a method executed by a system configured to create and distribute non-fungible tokens, the flowchart containing a further portion of the steps of the method, the steps of FIG. 4C being combined with the steps of FIGS. 4A and 4B to show the method, according to at least some embodiments disclosed herein.

### DESCRIPTION OF THE PREFERRED EMBODIMENTS

Reference will now be made in detail to each embodiment of the present invention. Such embodiments are provided by way of explanation of the present invention, which is not intended to be limited thereto. Those of ordinary skill in the art will appreciate upon reading the present specification and viewing the present drawings that various modifications and variations can be made thereto.

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by an “engine” or processor. Thus, the methods and systems of the present invention may be performed by a computer or computing device having a processor based on instructions received by computer applications and software.

The term “electronic device,” “mobile device,” “client device,” as used herein is a type of computer comprising circuitry and configured to generally perform functions such as recording audio, photos, videos and handwritten notes; displaying or reproducing audio, photos, videos and handwritten notes; storing, retrieving, or manipulation of electronic data; providing electrical communications and network connectivity; or any other similar function. Non-limiting examples of electronic devices include: personal computers (PCs), workstations, laptops, tablet PCs, cell phones, digital music players, digital notepads, digital pens or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as smartwatches, fitness rings, fitness trackers, etc.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or t lovable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include WIFI and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VOW) network.

As used herein, the term “database” shall generally mean a digital collection of data or information. A database may be stored on a remote server and accessed by a client device through the Internet (e.g., the database is in the cloud) or alternatively in some embodiments the database may be stored on the client device or remote computer itself (e.g., local storage). A “data store” as used herein may contain or comprise a database (e.g., information and data from a database may be recorded into a medium on a data store).

### Blockchains

As described herein, the term “blockchain” refers to a distributed database that maintains a continuously growing ledger or list of records, called “blocks,” secured from tampering and revision using hashes. Every time data is published to a blockchain database, the data may be published as a new block. Each block may include a timestamp and a link to a previous block. Through the use of a peer-to-peer network and a distributed timestamping server, a blockchain database is managed autonomously.

Permissionless blockchains are an open, distributed ledger that can record transactions between two parties efficiently and in a verifiable and permanent way. It should be appreciated that permissioned blockchains are also targeted with this present invention. Consensus ensures that the shared ledgers are exact copies, which lowers the risk of fraudulent transactions. Cryptographic hashes, such as the SFL256 computational algorithm, ensure that any alteration to transaction input results in a different hash value being computed, which indicates a potentially compromised transaction input. Digital signatures ensure that transactions originated from senders (signed with private keys) and not imposters. This covers different approaches to the processing, including hash trees and hash graphs. At its core, a blockchain system records the chronological order of transactions with all nodes agreeing to the validity of transactions using the chosen consensus model. As a result, transactions are irreversible and agreed to by all members in the network.

An example of a use of a blockchain is a cryptocurrency. The cryptocurrency is generated when new blocks are created on the blockchain to confirm transactions of the cryptocurrency. The new blocks may confirm the transfer of cryptocurrency generated in earlier blocks. The blocks on the blockchains are cryptographically proofed and linked to earlier blocks and served as an immutable record of the events in a trustless decentralized peer-to-peer network.

For example, a cryptocurrency (e.g., Bitcoin) is represented as a chain of events that transfers ownership from one party to another party on a blockchain without an intermediary, Each event transferring ownership from one party to another is cryptographically proofed by including the public key of the new owner. Further, each event is digitally signed with the current owner's private key.

A new block in a blockchain is filled with cryptographically proofed events until block reaches a specified size limit. A hash digest of all the event identifiers within the block and the block header of the previous block are added as the first event in the block. Each block of events may be secured by a race between participants on a peer-to-peer network. In order to win the race the participants collect new events to create the new block, validate the events on the new block by verifying the cryptographic proofs of each event to verify the cryptocurrency was not spent earlier, and solve a mathematical puzzle based on the hash digest, previous block header and a random number. Blockchain provides a mathematical hierarchy of verifiable events that is immutable and is verified at each stage by the race between the participants.

### Smart Contracts

The principles used in blockchains may be modified to allow for execution of smart contracts deployed on the blockchain. As defined herein, “smart contracts” are self-executing machine-readable instructions that store state information and are stored on the blockchain. When deployed, the smart contract is assigned a unique address to allow communication to and from the smart contract through messages. The smart contract is deployed by storing the smart contract as an event on the blockchain Ethereum™ blockchain). Messages to the smart contract may he posted as events on the blockchain. The smart contract may contain machine-readable instructions and data. designed to execute on virtual machines.

Further, the smart contract may have the ability to read or write to its internal storage storing data, read the storage of a received message, and/or send messages to other smart contracts to trigger execution of the code in other distributed applications. When the smart contract is executed on a virtual machine running on the peers securing the blockchain, the resulting data may be saved in the internal storage of the smart contract. The updated smart contract may be stored as an event on a new block. Thus, the smart contract and changes to data are represented as a series of events on the blockchain. Similar to the cryptocurrency blockchain, each block in the blockchain by mining the blockchain by peers based on a consensus protocol.

For example, in a smart contract that governs a sale of an electronic asset, the smart contract may include machine-readable instructions to access its internal storage, to read the storage of a message sent to the smart contract and to process the data in a received message, such as a counter-offer from a buyer. When the buyer sends a counter-offer to the smart contract, the smart contract may update its internal storage to include the counter-offer event, such as the identity of the buyer. The updated smart contract may be recorded as an event (e.g., a transaction) on a new block on the blockchain. As such, the blockchain stores the changes in the state of the smart contract as a series of events (e.g. a transaction).

### Cryptographic Digital Assets

As explained, the smart contract governs a sale of an electronic asset, a “cryptographic digital asset,” or a “digital asset,” which refers to any computer-generated virtual object, including digital apparel, avatars, pets, art, etc., that have a unique, non-fungible tokenized code (“NFT”) registered on and validated by a blockchain platform or registered in an immutable database. Specifically, NFT's describe blockchain-based cryptographic tokens that are created with respect to a specific piece of content, which incorporate programmatically defined digital rights management. The metadata associated with an NFT may also include digital media assets such as, but not limited to, images, videos about the specific NFT or the context in which it was created (studio, film, hand, company song etc.). In a number of embodiments, content creators can issue NFTs to users within the platform.

In many instances, each NFT has a unique serial number and the NFT smart contract defines an interface that enables the NFT to be managed, owned and/or traded. Standards for defining interfaces for building NFTs on the Ethereum blockchain include: ERC-721 and/or ERC-1155, among others, the disclosures of which are incorporated by reference in their entirety. NFTs can be contrasted with interchangeable or fungible tokens (e.g. Ether). Fungible tokens can be implemented on the Ethereutn blockchain based upon standard interfaces, such as the ERC-20 standard, the disclosure of which is incorporated by reference in its entirety.

In a number of embodiments, the smart contracts defining NFTs that can be minted within platforms specify fee distribution obligations with respect to specific types of transactions involving NETS. In several embodiments, the sale of an NFT within a platform can result in one or more residual royalty payment transactions that are recoded in the blockchain, such as: a residual royalty payment to the content creator that minted the NFT, an Artificial Intelligence (AI) programmer, and/or an Al Application Programming Interface (API) provider.

In some examples, the authenticity of a particular NFT can be verified independently of the content creator by auditing transaction records associated with the NFT within the blockchain to confirm consistency with the smart contract underlying the NFT. For example, the presence of transactions reflecting residual royalty payments that a smart contract indicates should have occurred upon transfers of the NFT can be relied upon to verify the authenticity of the NET. Moreover, in embodiments, “wallet applications” enable users to securely store NFTs and/or other tokens on their devices.

### Invention

The preferred embodiment; of the present invention will now be described with reference to the drawings. Identical elements in the various figures are identified with the same reference numerals.

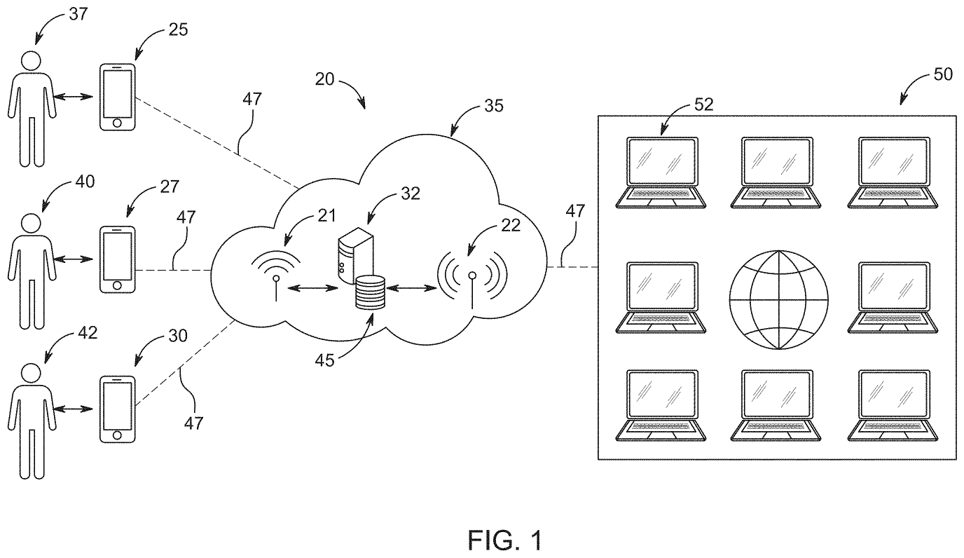

FIG. 1 depicts a schematic diagram of a system 20 configured to create and distribute non-fungible tokens via a blockchain, according to at least some embodiments disclosed herein. The system 20 of FIG. 1 is configured to facilitate the transfer of data and information between one or more access points 21, 22, one or more client devices 25, 27, and 30, and one or more servers 32 over a data network 35. It should be appreciated that the quantity of the one or more client devices 25, 27, and 30 is not limited to any particular quantity. Moreover, it should be appreciated that a first client device 25 of the one or more client devices 25, 27, and 30 is associated with a first user 37, a second client device 27 of the one or more client devices 25, 27, and 30 is associated with a second user 40, and a third client device 30 of the one or more client devices 25, 27, and 30 is associated with a third user 42, respectively.

Each of the one or more client devices 25, 27, and 30 may be a mobile device, a laptop, a tablet computer, a smart phone, a personal digital assistant, etc., that is equipped with a wireless network interface capable of sending data to the one or more servers 32 with access to one or more data stores 45 over the data network 35, such as a wireless local area network (WLAN). Additionally, in other embodiments, each of the one or more client devices 25, 27, and 30 may be physical fixed devices that are equipped with a wireless or wired network interface capable of sending data to the one or more servers 32 with access to the one or more data stores 45 over a wireless or wired local area network.

The present invention may be implemented on at least one client device of the one or more client devices 25, 27, and 30 and/or at least one server of the one or more servers 32 programmed to perform one or more of the steps described herein. In some embodiments, more than one of the one or more client devices 25, 27, and 30 and/or the one or more servers 32 may be used, with each being programmed to carry out one or more steps of a method or process described herein. Each of the one or more client devices 25, 27, and 30 may send data to and receive data from the data network 35 through a network connection 47 with an access point of the one or more access points 21, 22. The one or more data stores 45 may contain one or more databases (such as a distributed blockchain database and/or a ledger blockchain database, among others).

The system 20 also includes a blockchain network 50 that comprises one or more nodes 52, which may be in communication with one or more servers 32, and/or the one or more client devices 25, 27, and 30. A node of the one or more nodes 52 may be a server of the one or more servers 32, a client device of the one or more client devices 25, 27, and 30, or any other suitable networked computing platform. The blockchain network 50 may manage a distributed. blockchain database that contains data recorded by the system 20. This data may be maintained as a continuously growing ledger or listing, which may be referred to as blocks, secured from tampering and revision. Each block includes a timestamp and a link to a previous block.

Through the use of a peer-to-peer blockchain network 50 and a distributed timestamping server of the one or more servers 32, a ledger blockchain database may be managed autonomously. Consensus ensures that the shared ledgers are exact copies, and lowers the risk of fraudulent transactions. Cryptographic hashes are used to ensure that any alteration to transaction data input results in a different hash value being computed. Further, digital signatures ensure that data entry transactions (e.g., data added to the ledger blockchain database) originated from senders (signed with private keys). Further, the ledger blockchain database may record the chronological order of data entry transactions with the one or more nodes 52 agreeing to the validity of entry transactions using the chosen consensus model. The result is data entry transactions that are irreversible and agreed to by all members in the blockchain network 50.

Moreover, the blockchain network 50 may comprise a cryptocurrency or digital asset designed to work as a medium of exchange that uses cryptography to: secure its transactions, to control the creation of additional units, and to verify the transfer of assets. Example cryptocurrencies include Bitcoin, Etherium, Ripple, etc. The blockchain network 50 may also comprise tokens common to cryptocurrency based blockchain networks 50.

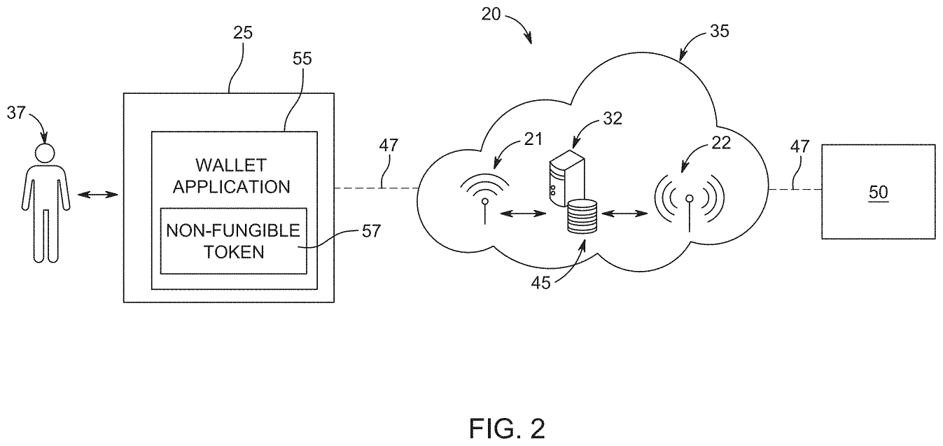

FIG. 2 depicts another schematic diagram of the system 20 configured to create and distribute non-fungible tokens via a blockchain network 50, according to at least some embodiments disclosed herein. FIG. 2 shows the client device 25 as having a wallet application 55 in which is contained a non-fungible token 57.

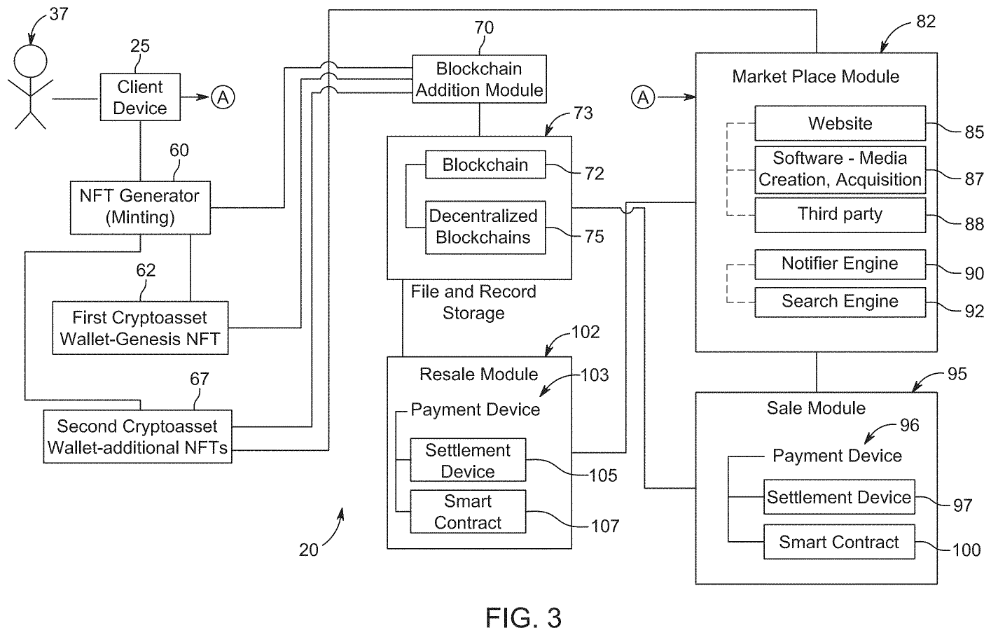

FIG. 3 shows a schematic view of the components and interconnections between the components which comprise an embodiment of the system 20. Methods of operating these components will be described in detail below. The following will identify the components of the system and their interconnections and, for some components, describe their function.

The user, e.g., the first user 37, operates the first client device 25 to enable the user to control certain components of the system 20. The client device 25 is connected to the NFT Generator 60. The NFT Generator 60 creates the Genesis NET from the digital media. The Genesis NFT is the original NET. The creation of the Genesis NFT may be referred to as “minting.” The NFT Generator 60 is connected to a blockchain addition module 70 for recording information about the Genesis NFT on a blockchain 72. The NET Generator 60 is connected to a first cryptoasset wallet 62 for storing the Genesis NFT. The NET Generator 60 creates additional NFL's from the digital media that are copies of the Genesis NET. The additional NETs are stored in a second cryptoasset wallet 67.

The first and second cryptoasset wallets 62, 67 are connected to the blockchain addition module 70. The blockchain addition module 70 receives information regarding the Genesis NFT and additional NFTs. The blockchain addition module 70 is connected to a blockchain 72 of a File and Record Storage Module 73. The blockchain addition module 70 transmits the information regarding the Genesis NFT and additional NFTs to the blockchain 72. The blockchain 72 is connected to decentralized blockchains 75 of the file and record storage module 73. The decentralized blockchains 75 receive the information regarding the Genesis NFT and additional NFTs from the blockchain 72.

The second cryptoasset wallet 67 is also connected to a marketplace module 82. This enables the additional NFTs that come from the second cryptoasset wallet 67 to be provided to the marketplace module 82 for future sales and possible resales to buyers.

The marketplace module 82 includes a website 85 and software 87 used to create or acquire the original digital media file, The module 82 may be controlled the website 85 which may, in turn, be controlled by the software 87. The software 87 may alternatively be situated in the client device 25. Alternative control of the marketplace module 82 may be provided by a third-party.

The marketplace module 82 includes a notifier engine 90 which notifies prospective buyers of the additional NFTs that come from the second cryptoasset wallet 67. The notifier engine 90 is activated by the controller of the marketplace module 82. The marketplace module 82 also includes a search engine 92 which allows prospective buyers to search for and review the additional NFTs that come from the wallet 67. The search engine 92 is activated by the controller of the marketplace module 82.

The marketplace module 82 is connected to a sale module 95. The sale module 95 receives one or more additional NFTs (individual or bundled) from the marketplace module 82. The receipt by the sale module 95 of the one or more additional NFTs (individual or bundled) enables the transfer of the NFTs to a buyer and remittance for the transfer to the user 37. The remittance is provided to the user 37 by a payment device 96 included in the sale module 95. The payment device 96 may be a settlement device 97 which provides a conventional electronic remittance (e.g., wire transfer or credit card payment) to the user 37. Alternatively, the payment device 96 may be a smart contract 100 which provides cryptocurrency remittance to the user 37. The sale module 95 is connected to the file and record storage module 73 to enable the sale of the one or more additional NFT (individual or bundled) to the buyer to be written on the blockchain 72 and decentralized blockchains 75.

A resale module 102 is connected to the file and record storage 73 to enable a second buyer to ascertain the ownership by the buyer of one or more of the additional NFTs (individual or bundled) from the blockchain 72 and decentralized blockchains 75. The buyer is referred to as the first buyer hereinafter. The resale module 102 is also connected to the marketplace module 82 to capture royalties from the resale of one or more of the additional NFTs (individual or bundled) and remit such royalties to the account of the user 37.

The resale module 102 enables the sale of one or more additional NETS (individual or bundled) from the first buyer to the second buyer. The proceeds from the sale are provided to the first buyer by a payment device 103 included in the resale module 102. The payment device 103 may be a settlement device 105 which provides a conventional electronic remittance (e.g., wire transfer or credit card payment) to the first buyer. Alternatively, the payment device 103 may be a smart contract 107 which provides cryptocurrency remittance to the first buyer. The resale module 102 is connected to the file and record storage module 73 to enable the transfer of the additional NFTs (individual or bundled) to the second buyer to be written on the blockchain 72 and decentralized blockchains 75.

### Operation

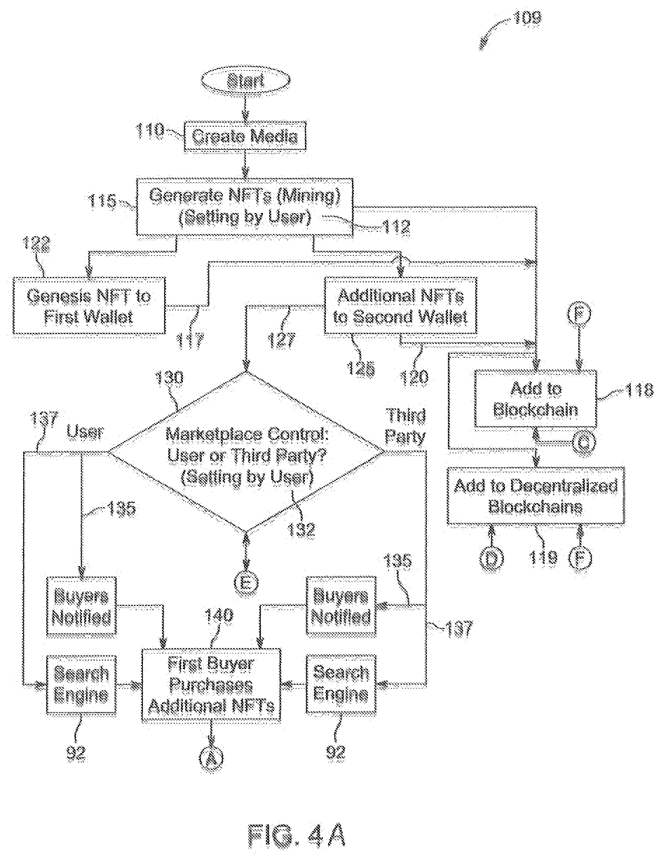

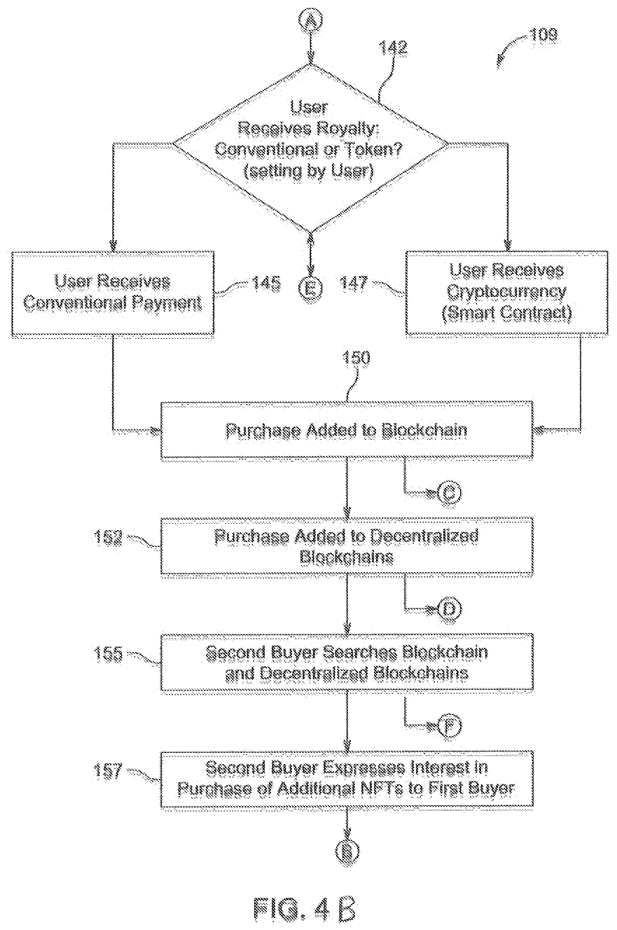

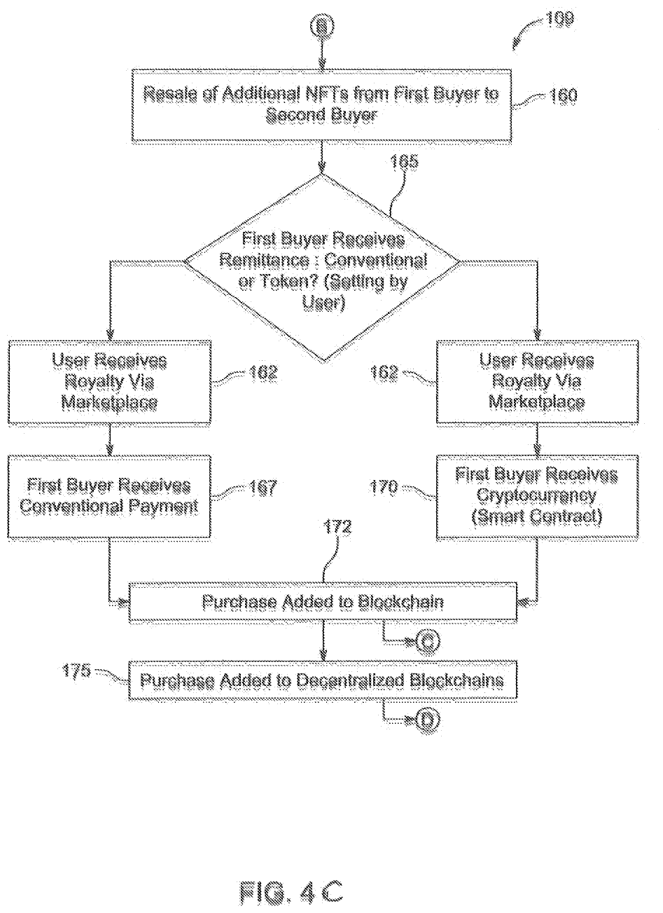

FIGS. 4A to 4C, with references to FIG. 3, shows a method 109 for operating the system 20 which begins with the one of the users, e.g., user 37 grasping the client device 25 and using the device to create new entertaining or interesting digital media 110. This digital media may include a photo or video using a camera phone, an audio or text recording using a smartphone, or a third party application, such as TikTok, YouTube, OnlyFans, Patreon, etc. The digital media may also include digital art, digital entertainment, digital video, digital voice recording, digital image, digital. document, or similar. Instead of the digital media being created by the user 37 employing the client device 25, the digital media may have been previously stored on a device, whether mobile, laptop, desktop, or similar, computerized hardware unit, or may be a digital media file newly created using a software application or input device on the aforementioned hardware apparatus.

The digital media created by the user 37 or previously created digital media may be stored on the client device 25. Before or after the client device 25 has access to the digital media, the system 20 is activated by the user 37 by acknowledging prompts in the settings of the application. The prompts may be acknowledged by the user 37 pushing a digital button, swiping, or tapping on the screen of the client device 25 (once).

Immediately after the system 20 is activated by the user 37, the digital media is sent to the NFT Generator 60 through a mobile or web application. The Generator 60 creates an NFT 115 which replicates the digital media created by the user 37. The Genesis NFT is the original NFT. This process of creating an NFT is referred to as minting. The NET resulting from the replication is the Genesis NFT.

Information about the Genesis NET is sent 117 to the blockchain addition module 70 for recording 118, 119 on the blockchain 72 and decentralized blockchains 75 of the file and record storage 73. This information includes the date and time of the creation of the Genesis NFT, identifiable ownership information, and identifying information regarding the digital media file. Information regarding the Genesis NFT recorded on the blockchain 72 and decentralized blockchains 75 further includes the location, origin, and format of the digital media file; and similar data.

Contemporaneous with the generation of the Genesis NFT, additional NFTs are created 115 by the NTT Generator 60 from the digital media. The additional NFTs are copies of the Genesis NFT, The number of additional NFTs depends on settings 112 chosen by the user 37. Information and data about the additional NFTs is added to the file and record storage 73 by initially being sent 120 to the blockchain addition module 70 which, in turn, transmits the information and data to the blockchain 72 and decentralized blockchains 75. The information and data is then recorded 118, 119 on the blockchain 72 and decentralized blockchains 75. This information includes the date and time of the creation of the additional NFTs, identifiable ownership information, and identifying information regarding the digital media file. Information regarding the additional NFTs recorded on the blockchain further includes the location, origin, and format of the digital media file; similar data; and the sequential order number of the additional NFTs. For example, if 2,000 additional “NFTs” were chosen to be created, one would be numbered “1 of 2000”, the next would be numbered “2 of 2000”, the next would be numbered “3 of 2000”, and so on.

The created NFTs, without additional action by the user 37, will initially be stored in a previously set up cryptoasset wallet, the location and public key of which would be recorded in the previous step on the blockchain 72 and decentralized blockchains 75.

The Genesis NFT and additional NFTs are immediately stored in the cryptoasset wallets. The Genesis NFT may be stored 122 in a first cryptoasset wallet 62 separated from all additional NFTs. This embodiment is shown in FIG. 4A in which the Genesis NFT is stored 122 in the first cryptoasset wallet 62. The Genesis NFT remains in the first cryptoasset wallet 62 and is not distributed, available only to the user 37 or creator, until additional actions are possibly taken at a later date or time. The additional NFTs are stored 125 in a second cryptoasset wallet 67. in another embodiment of the system 20, the Genesis NFT may be stored in the same cryptoasset wallet as the additional NFTs.

The connection of the second cryptoasset wallet 125 to the marketplace module 82 enables the module 82 to draw one or more of the additional NTTs from the second cryptoasset wallet to be delivered 127 in the marketplace module, Such a deliver 127 may occur at various times such as just after a sale has been agreed upon, or well before or after such a sale.

The marketplace module 82 is controlled 130 by a marketplace or website 85. The marketplace may be controlled 130 by a third-party, or by the software 87 used to create or acquire the. original digital media file, Alternatively, the marketplace module 82 may be controlled 130 by the website 85 which, in turn, is controlled 130 by the software 87. The manner in which the marketplace module 82 is controlled 130, e.g., the marketplace or website 85, depends on the settings the user chose 132 when previously interacting with the system 20.

After the marketplace module 82 has received the additional NFTs, the notifier engine 90 markets 135 the additional NFTs to individual or collective parties that have been previously identified to the user 37, or which such parties may currently have acknowledged interest in the user, by any of a number of different methods, such as, but not limited to, electronic mail communications, Internet communications, mobile communications, SMS or text communications, digital communications, electronic notifications, mobile haptic notifications, or similar. The user 37 communicates 135 to the interested party, information such as, but not limited to, that the user has created and distributed a set of “NFTs”, the number of “NFTs” distributed, the location to, or link to, the marketplace module 82 where the “NFTs” are available, or similar. This is performed by the notifier engine 90 without additional action by the user 37.

Also after the marketplace module 82 has received the additional NFTs, the search engine 92 allows collectors, or those interested in acquiring NFTs from one or multiple creators, to view, search and learn 137 detailed information about the NFTs that have been created by the user 37.

The marketplace module 82 allows the user 37 to choose to market their NFTs on marketplaces individually, or agree to have them bundled with other NFTs randomly to make bulk purchasing by certain collectors more attractive. The marketplace module 82 also allows the user 37 to have their NFTs bundled with other NFTs such that collectors are allowed to buy multiple “NFTs” from one or multiple creators together in a bundle, without previously having viewed any or all of the “NFTs” in the bundle, perhaps for a lower price collectively than each “NFT” would add up to as a sum of individual purchases, similar to how collectors buy baseball cards.

Further, the marketplace module 82 may allow collectors to request NFTs from other creators. In an alternative embodiment, the marketplace module 82 may be used by entities, such as corporate, organizational, or otherwise, to promote their consumer or business brand or intellectual property by engaging with creators to create NFTs featuring the promoted brand, theme or intellectual property. Such NFTs may then be marketed in the same manner as the NFTs of the user 37.

The marketplace module 82 is able to receive a communication from the first buyer who expresses interest in purchasing one or more additional NFTs individually or bundles. When such a communication is received, the marketplace module 82 transfers the one or more additional NFTs (individual or bundled) which the first buyer seeks to the sale module 95. The sale module 95 transfers 140 the sought after one or more additional NFTs (individual or bundled) to the first buyer and requires payment 140 from the first buyer to the user 37 using a wire transfer/credit card, or cryptocurrency depending on settings chosen by the user 142. Payment by wire transfer or credit card is executed 145 by the conventional settlement device 97. Payment by cryptocurrency is executed 147 by the smart contract 100. The sale module 95 is connected to the file and record storage module 73 to enable the sale of the one or more additional NFTs (individual or bundled) to the first buyer to be written 150, 152 on the blockchain 72 and decentralized blockchains 75, respectively.

The ownership by the first buyer of one or more of one or more of the additional NFTs (individual or bundled) may be ascertained 155 by a second buyer from the blockchain 72 and decentralized blockchains 75. The second buyer may communicate 157 an interest in purchasing one or more of the additional NFTs (individual or bundled) from the first buyer. The one or more additional NFTs (individual or bundled) are required to be sold through a resale module 102. The first buyer is required to provide access to the resale module 102 of the one or more NFTs (individual or bundled) that the first buyer plans to sell to the second buyer. The resale module 102 may receive instructions from the first buyer to transfer the additional NFTs (individual or bundled) to the second buyer, and require payment from the second buyer to the first buyer 160.

The connection of the resale module 102 to the marketplace module 82 enables the resale module to receive instructions from the marketplace module to remit a portion of the payment 162 from the second buyer to the first buyer to the marketplace module 82. The remittance is typically in the form of cryptocurrency or some other form of electronic payment. The marketplace module 82 then causes the remittance to be credited to an account 162 of the user 37. Consequently, the user 37 may receive royalties on every resale unless the protocol of remitting a portion of the payment from the second buyer to the first buyer to the marketplace module 82 is changed.

The payment from the second buyer to the first buyer may be by wire transfer/credit card, or cryptocurrency depending on settings chosen 165 by the user 37. Payment by wire transfer or credit card is executed 167 by the conventional settlement device 105. Payment by cryptocurrency is executed 170 by the smart contract 107. The connection of the resale module 102 to the file and record storage module 73 enables the sale of the one or more additional NFTs (individual or bundled) to the second buyer to be written 172, 175 on the blockchain 72 and decentralized blockchains 75, respectively.

Although this invention has been described with a certain degree of particularity, it is to be understood that the present disclosure has been made only by way of illustration and that numerous changes in the details of construction and arrangement of parts, methods and sequences may be resorted to without departing from the spirit and the scope of the invention.

What is claimed is:

1. A computer implemented system and method for the automatic creation, storage, distribution and marketing of non-fungible tokens from previously created digital media upon the completion of one designated action by the creator.

2. A system for creating and distributing non-fungible tokens comprising:
a client device for receiving instructions from a user, said client device constructed to receive and store electronic media, said client device further constructed to electronically transmit the media to other devices:
a non-fungible token generator connected to said client device, said generator constructed to electronically receive the media from said client device, said generator further constructed to create a non-fungible: token that can produce media substantially the same as the media received from said client device;
a blockchain connected to said generator, said blockchain constructed to electronically receive information identifying the token from said generator and writing the information on said blockchain; and
a marketplace module connected to said generator, said marketplace module constructed to electronically receive the token from said generator, said marketplace module constructed to electronically transfer the token to a buyer and receive electronic payment from the buyer in exchange for the transfer, said marketplace module constructed to electronically transmit the payment to the user.

3. A system according to claim 2, and further comprising a first cryptoasset wallet connected to said non-fungible token generator such that a Genesis non-fungible token produced by said token generator is received in said first cryptoasset wallet.

4. A system according to claim 3, and further comprising a second cryptoasset wallet connected to said non-fungible token generator such that additional non-fungible tokens produced by said token generator are received in said second cryptoasset wallet.

5. A system according to claim 3, and further comprising decentralized blockchains connected to said first and second cryptoasset wallet for receiving information regarding the Genesis token and additional tokens.

6. A system according to claim 2 wherein said marketplace module includes a website for controlling said marketplace module.

7. A system according to claim 2 wherein said marketplace module includes a notifier engine for notifying prospective buyers of the availability for sale of the token,

8. A system according to claim 2 wherein said marketplace module includes a search engine for enabling prospective buyers to search for a preferred token originating from a second cryptoasset

9. A system according to claim 2, and further comprising a sate module connected to said marketplace module wherein, prior to the transfer of the token to the buyer, the token is transferred from said marketplace module to said sale module such that the transfer of the token to the buyer and receipt of the electronic payment in exchange for the transfer occurs in said sales module, said sales module connected to said blockchain such that said blockchain electronically receives information identifying the transfer of the token to the buyer, said blockchain constructed to write the information regarding the transfer of the token on said blockchain.

10. A system according to claim 9 wherein said sale module includes a settlement device for providing a conventional electronic remittance in exchange for the transfer of the token.

11. A system according to claim 9 wherein said sale module includes a smart contract for providing a crypto currency remittance in exchange for the transfer of the token.

12. A system according to claim 2 and further comprising a resale module connected to said marketplace module, said resale module constructed to resell one or more of the tokens, said resale module constructed to electronically notify said marketplace module of the resale, said resale module constructed to send a portion of the proceeds of the resale to said marketplace module, said marketplace module constructed to send the portion of the proceeds to the user.

13. A system according to claim 12 wherein said resale module includes a settlement device for providing a conventional electronic remittance in exchange for the transfer of the token.

14. A system according to claim 12 wherein said resale module includes a smart contract for providing a cryptocurrency remittance in exchange for the transfer of the token.

15. A system according to claim 12 wherein said resale module is connected to said blockchain wherein the blockchain is constructed to write the information regarding the resale of the token on said blockchain.

16. A method for creating and distributing non-fungible tokens comprising:
creating electronic media using a client device;
electronically transmitting the media from a client device to a non-fungible token generator connected to the client device;
employing the generator to create a token that can produce media substantially the same as the media received from the client device electronically transmitting information regarding the token to a blockchain connected to the generator;
employing the blockchain to write the information regarding the token on the blockchain;
electronically transferring the token from the generator to a marketplace module connected to said generator;
electronically transferring the token from the marketplace module to a buyer;
employing the marketplace module to receive electronic payment from the buyer in exchange for the transfer;
employing the marketplace module to electronically transmit the payment to the user;
employing the marketplace module to write information regarding the transfer of the token to the buyer;
employing the marketplace module transmit the information regarding the transfer of the token to the buyer to the blockchain; and
employing the blockchain to write the information regarding the transfer of the token to the buyer on the blockchain.

17. A method according to claim 16, and further employing the blockchain to write the transfer of the token on the blockchain.

18. A method according to claim 17, wherein a second buyer is able to search the blockchain for the token and locate the token on the blockchain,
electronically transferring the token from the buyer to the second buyer;
electronically transferring payment to the buyer from the second buyer in exchange for the transfer of the token;
employing the marketplace module to electronically transmit a royalty payment to the user from the payment of the second buyer; and
employing the marketplace module to write information regarding the transfer of the token to the second buyer;
employing the marketplace module transmit the information regarding the transfer of the token to the second buyer to the blockchain; and
employing the blockchain to write the information regarding the transfer of the token to the second buyer on the blockchain.

19. A method according to claim 16, wherein the marketplace notifies the buyer of the availability of the token for purchase before the token is transferred to the buyer.

20. A method according to claim 16, wherein the token defines a first token, the marketplace containing a plurality of additional tokens which differ from the first token,
enabling the buyer to search the tokens in the marketplace to locate the first token among the other tokens thereby to facilitate the transfer of the first token to the buyer.
